(19) United States
(12) Patent Application Publication
(10) Pub. No.: US 2019/0388727 A1
(43) Pub. Date: Dec. 26, 2019

(54) SERVER APPARATUS AND TERMINAL DEVICE

(71) Applicant: CASIO COMPUTER CO., LTD., Tokyo (JP)

(72) Inventor: Hirokazu Kanda, Ome-shi (JP)

(21) Appl. No.: 16/446,379

(22) Filed: Jun. 19, 2019

(30) Foreign Application Priority Data
Jun. 22, 2018 (JP) 2018-118459

(51) Int. Cl. A63B 24/00; G06F 8/65

(52) U.S. Cl. CPC A63B 24/0003; A63B 24/0062; G06F 8/65

(57) ABSTRACT

There is provided a data processing system in which a terminal device and a server apparatus are connected via a network. The terminal device includes a first analysis unit configured to analyze the input data, using software of the terminal device, and a first transmitter configured to transmit the input data and an analysis result. The server apparatus includes a second analysis unit configured to analyze, using software of the server apparatus, the data received from the terminal device, and a second transmitter configured to transmit information for updating the software of the terminal device, based on the analysis result received from the terminal device and an analysis result obtained by the second analysis unit.

### CROSS-REFERENCE TO RELATED APPLICATIONS

This application is based upon and claims the benefit of priority from Japanese Patent Application No. 2018-118459, filed Jun. 22, 2018, the entire contents of which are incorporated herein by reference.

### BACKGROUND OF THE INVENTION

### 1. Field of the Invention

The present invention relates to a server apparatus and a terminal device which are suitable when a terminal-side device is in a network environment.

### 2. Description of the Related Art

In modern computers, peripheral devices, household products, etc., software for controlling hardware is assembled in a nonvolatile memory such as a flash memory. The software, in many cases, can be rewritten (updated) to a latest version, where necessary, by detaching the nonvolatile memory from such a device, or with the nonvolatile memory remaining attached in the device when the device is capable of direct network connection (e.g. Jpn. Pat. Appln. KOKAI Publication No. H11-003213).

### SUMMARY OF THE INVENTION

According to one aspect of the present invention, there is provided a data processing system in which a terminal device and a server apparatus are connected via a network, the terminal device comprising: an input unit configured to input data; a first analysis unit configured to analyze, using software of the terminal device, the data input by the input unit; and a first transmitter configured to transmit the data input by the input unit and an analysis result obtained by the first analysis unit, the data input by the input unit being associated with the analysis result obtained by the first analysis unit, and the server apparatus comprising: a second analysis unit configured to analyze, using software of the server apparatus, the data received from the terminal device, the software of the server apparatus being different from the software of the terminal apparatus and having a higher precision than the software of the terminal apparatus; and a second transmitter configured to transmit information for updating the software of the terminal device, based on the analysis result received from the terminal device and an analysis result obtained by the second analysis unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view exemplarily illustrating a configuration of the entirety of a swing form analysis system according to an embodiment of the present invention;

FIG. 2 is a block diagram illustrating a functional configuration of electronic circuitry of a wearable terminal according to the embodiment;

FIG. 3 is a flowchart illustrating the processing content in the wearable terminal according to the embodiment; and

FIG. 4 is a flowchart illustrating the processing content in a server apparatus according to the embodiment.

### DETAILED DESCRIPTION OF THE INVENTION

Hereinafter, the present invention will be described in detail with reference to the accompanying drawings, in connection with one embodiment in which the invention is applied to a data processing system including a wearable terminal with a communication function, which executes data analysis, and a server apparatus which updates software of the wearable terminal via a network.

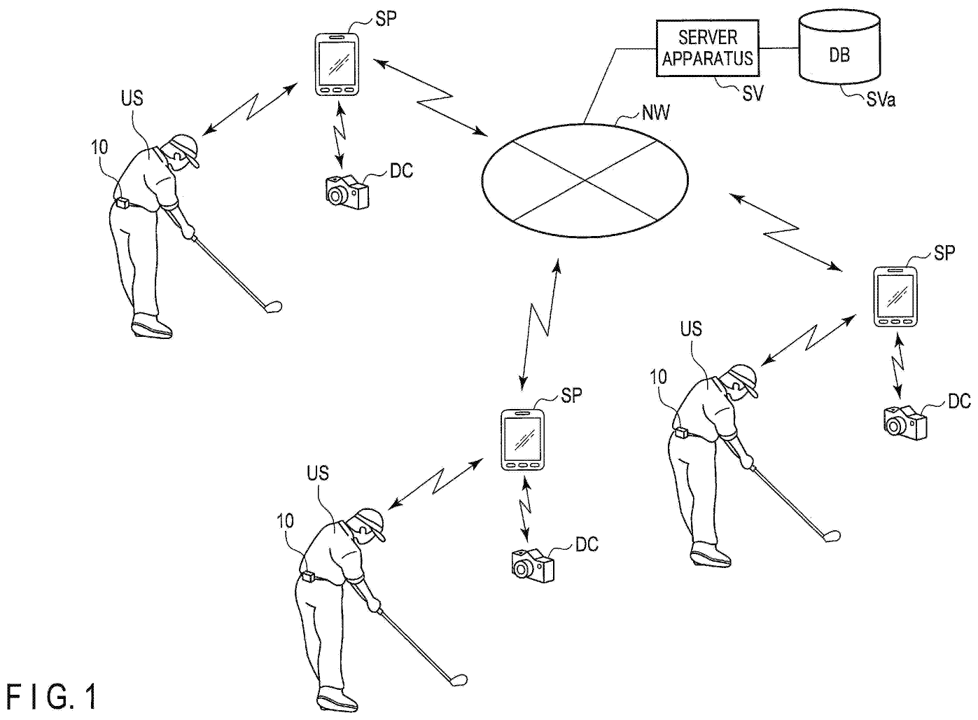

FIG. 1 is a view illustrating a configuration of the entirety of the data processing system. In FIG. 1, a user US performs a golf swing in the state in which a wearable terminal 10 is attached to a waist belt of the user US. A digital camera DC is installed near the user US, and the digital camera DC captures a moving image of the swing form of the user US.

The wearable terminal 10 senses sequential movements in the golf swing of the user US. Based on sensor data which was sensed, the wearable terminal 10 analyzes the posture of the user US during the golf swing, and analyzes the movements which constitute the golf swing, such as an address, takeback, downswing, follow and finish. The wearable terminal 10 transmits the analysis result to a device (a PC or the like) which is other than the wearable terminal 10. The user US confirms the analysis result which is displayed on a display of the other device (PC or the like), and makes use of the analysis result, for example, in order to improve the form.

In addition, both the wearable terminal 10 and the digital camera DC are wirelessly connected to a smartphone SP.

Specifically, the smartphone SP and wearable terminal 10 are connected by, for example, Bluetooth (trademark) LE (Low Energy) technology, which is short-range wireless communication technology. The above-described sensor data, in which the sequential movements in the golf swing of the user US are sensed, and the analysis result of analysis based on the sensor data, are transmitted from the wearable terminal 10 to the smartphone SP. On the other hand, the smartphone SP and digital camera DC are connected by, for example, IEEE802.11a/11b/11g/11n technology that is wireless LAN technology, or Bluetooth (trademark) technology. The moving image data of the swing form of the user US, which was captured by the digital camera DC, is transmitted from the digital camera DC to the smartphone SP.

The smartphone SP is connected to a server apparatus SV, which executes update of software of the wearable terminal 10, via a network NW including, for example, a base station of the 4th generation mobile telephone system and the Internet.

When the smartphone SP executes a preinstalled application program that is exclusive for the wearable terminal 10, the smartphone SP transmits to the server apparatus SV the data, etc. obtained by the wearable terminal 10, and the moving image data captured by the digital camera DC.

In addition, the smartphone SP receives software of the latest version from the server apparatus SV, and transmits the software of the latest version to the wearable terminal 10 and causes the wearable terminal 10 to execute the setup of update of the software.

The server apparatus SV manages software of various products of the same kind as the wearable terminal 10 and software of various products relating to the wearable terminal 10. The server apparatus SV is connected to a database (DB) SVa. The database SVa also accumulates and stores data, etc. that are uploaded from many wearable terminals, etc., which are connected via the network NW.

Although FIG. 1 illustrates an example of the case in which the user US wearing the wearable terminal 10 checks the movements at the time of the golf swing, the wearable terminal 10 may not be used as the terminal device of data analysis that is exclusive for golf, and the wearable terminal 10 may be used for various kinds of analysis of other various activities, such as dancing, mountain-climbing, trekking, cycling and fishing.

In this case, the genre for use is selected by also using, for example, the smartphone SP. Thereby, information relating to the selected genre is additionally set in the data group obtained from the wearable terminal 10.

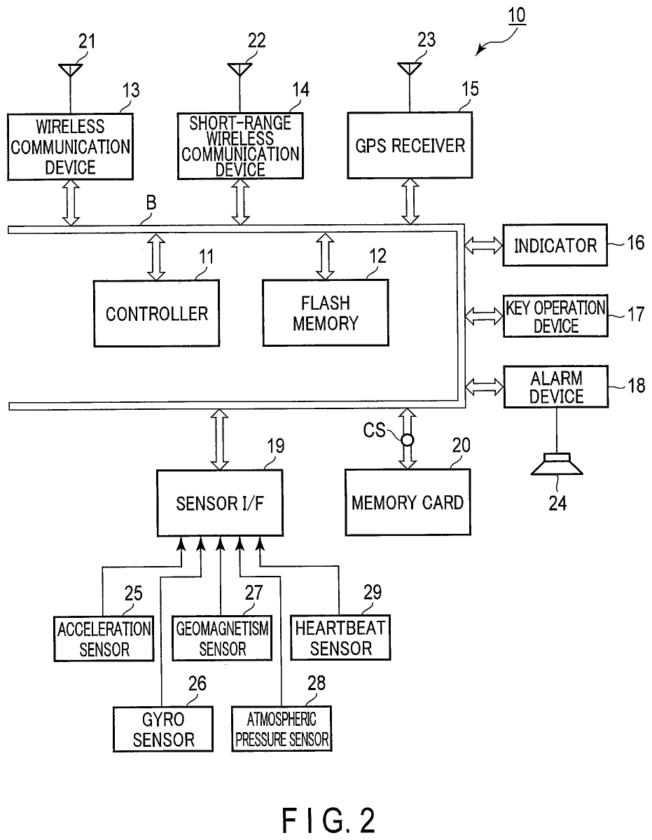

FIG. 2 is a block diagram illustrating a functional configuration of electronic circuitry of the wearable terminal 10. In FIG. 2, the wearable terminal 10 operates, with a controller 11 and a flash memory 12 functioning as principal components.

The controller 11 is composed of a CPU and a work memory. The controller 11 reads out software and various fixed data which are stored in the flash memory 12, loads them in the work memory, and successively executes operation programs of the software. Thus, the controller 11 comprehensively controls operations, etc. which will be described later.

A wireless communication device 13, a short-range wireless communication device 14, a GPS receiver 15, an indicator 16, a key operation device 17, an alarm device 18, a sensor interface (I/F) 19 and a memory card 20 are connected to the controller 11 and flash memory 12 via a bus B.

The wireless communication device 13 executes, when necessary, data communication with the external smartphone SP, etc., by an antenna 21, for example, by using wireless LAN technology by IEEE802.11a/11b/11g/11n standards.

The short-range wireless communication device 14 constantly executes, with lower power consumption than the above-described wireless communication device 13, data communication with the external smartphone SP, etc., by an antenna 22, for example, by using short-range wireless communication technology by Bluetooth (trademark) LE (Low Energy).

The GPS receiver 15 receives, by a GPS antenna 23, incoming radio waves from a plurality of GPS satellites (not shown), and calculates an absolute three-dimensional coordinate position (latitude/longitude/altitude) of the present position, and the present time.

The indicator 16 includes, for example, a red LED (light-emitting diode) and a driver of the red LED, and is turned on/off in accordance with ON/OFF of the operation of the wearable terminal 10.

The key operation device 17 accepts key operations of keys including a power key, which are provided on the wearable terminal 10, and sends operation key signals to the controller 11.

A speaker 24 is connected to the alarm device 18. At a time of operation, for example, when an irregular operation over a preset range, for example, is detected, the alarm device 18 causes, under the control of the controller 11, the speaker 24 to output an alarm such as buzzer sound.

For example, an acceleration sensor 25, a gyro sensor 26, a geomagnetism sensor 27, an atmospheric pressure sensor 28 and a heartbeat sensor 29 are connected to the sensor interface 19. The sensor interface 19 accepts a detection output of each sensor, and digitizes, when necessary, the detection output, and sends the detection output to the controller 11. The acceleration sensor 25 detects the posture (including a gravitational acceleration direction) of the user US wearing the wearable terminal 10 and a direction of applied external force, by detecting accelerations along three mutually orthogonal axes. The gyro sensor 26 is composed of, for example, a vibrating structure gyroscope, and detects a degree of a variation in attitude of the wearable terminal 10, by detecting angular velocities along three mutually orthogonal axes.

The geomagnetism sensor 27 is composed of, for example, a magnetoresistance effect element (MR sensor), and detects an azimuth in which the wearable terminal 10 moves, including a magnetic north direction.

By combining the detection outputs of the acceleration sensor 25, gyro sensor 26 and geomagnetism sensor 27, it is possible to obtain the locus of action, with consideration given to the azimuth based on Dead Reckoning in a three-dimensional space, even in an environment such as indoors, in which the absolute value of the present position cannot be detected by the GPS antenna 23 and GPS receiver 15.

The atmospheric pressure sensor 28 detects a variation of the atmospheric pressure state by detecting the atmospheric pressure. Further, in combination with the altitude information obtained from the output of the GPS receiver 15, the variation of the atmospheric pressure can also be used in order to estimate the altitude when GPS positioning is disabled later.

The heartbeat sensor 29 detects the heartbeat of the user US, for example, based on information representative of pulsation detected from a dedicated heartbeat band (not shown) which the user US wears on the chest.

The memory card 20 is detachably attached to the wearable terminal 10 via a card slot CS. The memory card 20 is provided in order to record various data which are detected by the wearable terminal 10, even in the state in which wireless connection to the smartphone SP is disabled.

It is assumed that the configurations of hardware circuitry in the inside of the smartphone SP and the inside of the server apparatus SV are the same as general well-known configurations, and thus the illustrations and descriptions of such configurations are omitted in the present embodiment.

Next, the operation of the present embodiment will be described.

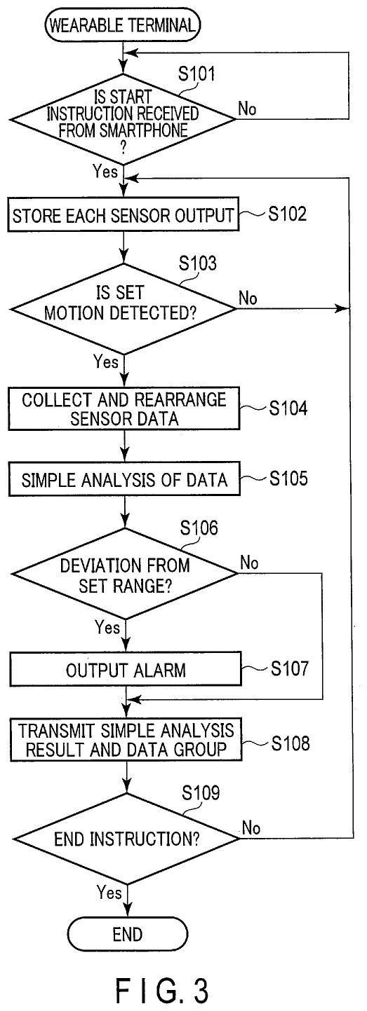

FIG. 3 is a flowchart illustrating the processing content executed in the wearable terminal 10, when a golf swing is performed in the state in which the wearable terminal 10 is attached to the user US, as illustrated in FIG. 1.

To start with, the controller 11 stands by until receiving an instruction from the smartphone SP, by repeatedly determining whether a signal, which instructs the start of operation, is received from the smartphone SP (step S101).

Note that when the smartphone SP transmits the signal to instruct the wearable terminal 10 to start operation, the smartphone SP also causes the digital camera DC to start a moving image capturing operation.

When the controller 11 determines that the signal which instructs the start of operation was received (Yes in step S101), the controller 11 acquires, through the sensor interface 19, sensor outputs which are used in a mode that is set at that time point, and stores and holds the sensor outputs (step S102).

When a mode for examining the golf swing by using the wearable terminal 10 is set, the controller 11 detects, for example, the output data of the acceleration sensor 25, gyro sensor 26, geomagnetism sensor 27 and heartbeat sensor 29, and stores and holds the output data.

Thereafter, the controller 11 determines, from the content of the held sensor output data, whether sequential movements in a set motion were detected or not (step S103).

For example, when a golf swing is set, this determination is made based on whether a corresponding sensor output of a finish movement, which is obtained at the timing of the finish of the sequential swing movements, was obtained or not.

When the controller 11 determines that sequential movements in the set motion are not detected (No in step S103), the controller 11 returns to the process from step S102.

In this manner, while repeatedly executing the process of steps S102 and S103, the controller 11 accumulates and holds the output data of the respective sensors.

Thereafter, in step S103, when the controller 11 determines that sequential movements in the set motion were detected (Yes in step S103), the controller 11 collects and rearranges the sequential output data of the sensors into a data file (step S104).

In addition, the controller 11 executes simple analysis of the content of the data, using the software of the wearable terminal 10 (step S105).

For example, in the case of the golf swing, the cycle of sequential movements, the rhythm of the entire action, a deviation amount of the rotational axis, etc., are calculated by the analysis.

The controller 11 determines, as a result of the simple analysis, whether there is an element which deviates from a preset tolerable range, and thereby determines whether there is an irregular portion in the sequential movements (step S106).

When the controller 11 determines, from the result of the simple analysis, that there is an element which deviates from the preset tolerable range and that there is an irregular portion in the sequential movements (Yes in step S106), the controller 11 causes the alarm device 18 to execute an alarm output by the speaker 24, such as generation of buzzer sound of, e.g. 0.5 [second] to 1.0 [second] (step S107).

In step S106, when the controller 11 determines, from the result of the simple analysis, that there is no element which deviates from the preset tolerable range and that there is no irregular portion in the sequential movements (No in step S106), the controller 11 does not execute the alarm output in step S107.

Thereafter, the controller 11 creates one data file by associating the file of the sequential output data of the sensors, which were collected and rearranged in step S104, with the simple analysis result, and causes the short-range wireless communication device 14 and antenna 22 to transmit the one data file to the server apparatus SV via the smartphone SP and network NW (step S108).

In the present embodiment, the data file transmission from the wearable terminal 10 to the server apparatus SV in step S108 is executed each time the analysis of the golf swing is executed. However, the data file transmission from the wearable terminal 10 to the server apparatus SV may be executed only when a predetermined operation by the user US was executed.

Thereafter, the controller 11 repeats the process of step S102 to step S109 until receiving an end instruction of the present process from the key operation device 17 (No in step S109). Upon receiving the end instruction of the present process from the key operation device 17 (Yes in step S109), the controller 11 terminates the sequential execution process.

The smartphone SP, which executes the relay operation of receiving the data file from the wearable terminal 10 and transmitting the data file to the server apparatus SV, transmits to the server apparatus SV the data file received from the wearable terminal 10 by associating the data file with the moving image file in which the user US is shot by the digital camera DC in the same time range as the data file.

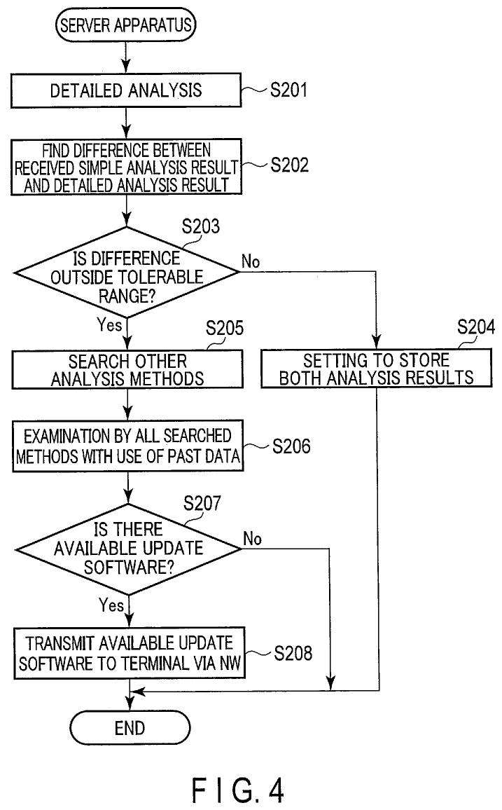

FIG. 4 is a flowchart illustrating the processing content that is executed by the server apparatus SV when the server apparatus SV receives the data, etc. from the wearable terminal 10 and the moving image file from the digital camera DC via the smartphone SP and network NW.

To begin with, the server apparatus SV executes a detailed analysis process, using the software of the server apparatus SV, by using the data of each sensor received from the wearable terminal 10 and the moving image file captured by the digital camera DC (step S201).

In the meantime, the database SVa accumulates data (data of many users US) of the respective sensors, which were received from many wearable terminals 10 that are connected to the network NW. In the analysis process executed in step S201, parameters, etc. at the time of the analysis process are always optimized based on such a large quantity of data. The software of the server apparatus SV is software different from the software of the wearable terminal 10, and has a higher precision than the software of the wearable terminal 10.

The server apparatus SV finds a difference between the thus obtained result by the detailed analysis process, and the simple analysis result calculated on the wearable terminal 10 side (step S202).

In finding this difference, the result of the simple analysis executed on the wearable terminal 10 side and the result of the detailed analysis executed by the server apparatus SV cannot simply be compared on the same level, since the server apparatus SV executes, as described above, the analysis by referring to form images, etc. by giving consideration to the moving image file of the user US, and the parameters, etc. at the time of the analysis process are optimized.

However, it is possible that, as regards a result “good” which was simply determined in the simple analysis on the wearable terminal 10 side, an analysis result that is clearly different in directivity is obtained in the detailed analysis on the server apparatus SV side, such as a determination that “the rhythm in motion is unstable, and the rotational axis of the swing deviates, and the analysis result is comprehensively not good”.

Thus, the server apparatus SV determines whether the difference between the two analysis results, including a difference in directivity, deviates from the preset tolerable range (step S203).

When the server apparatus SV determines that the difference between the two analysis results, including the difference in directivity, does not deviate from the preset tolerable range (No in step S203), the server apparatus SV determines that the software of the wearable terminal 10 requires no update, and executes such setting as to store in the database SVa the data including both analysis results and the received data (step S204), and once terminates the process of FIG. 4.

On the other hand, in step S203, when the server apparatus SV determines that the difference between the two analysis results, including the difference in directivity, deviates from the preset tolerable range (Yes in step S203), the server apparatus SV searches the software of the wearable terminals 10, which includes other simple analysis methods that are available for the update in the wearable terminal 10 (step S205).

Based on all software of the wearable terminals 10 including the analysis methods obtained as a result of the search, the server apparatus SV reads out from the database SVa the data received from the wearable terminals 10 in the past, and executes an examination by the simple analysis process (step S206).

As a result of the examination, the server apparatus SV determines whether there is update software that is available in the wearable terminal 10, by which an analysis result considered to be closest to the result of the detailed analysis process was obtained (step S207).

When the server apparatus SV determines that there is software that is available as update software in the wearable terminal 10, by which an analysis result considered to be closest to the result of the detailed analysis process was obtained (Yes in step S207), the server apparatus SV transmits this software to the wearable terminal 10 via the network NW and smartphone SP so that the wearable terminal 10 executes the setup for update of this software (step S208), and once terminates the process of FIG. 4.

Although many wearable terminals 10 are connected to the network NW, the update software transmission from the server apparatus SV to the wearable terminal 10 in step S208 is executed with respect to only the wearable terminal 10 which transmitted the sensor data and the simple analysis result to the server apparatus SV.

On the other hand, in step S207, when the server apparatus SV determines that an analysis result considered to be closest to the result of the detailed analysis process is not obtained and there is no update software that is available in the wearable terminal 10 (No in step S207), the server apparatus SV does not execute the process of step S208 and once terminates the process of FIG. 4.

As has been described above in detail, according to the present embodiment, the update of software can be executed, depending on the states of use of devices.

In addition, in the present embodiment, the wearable terminal 10 includes a plurality of kinds of sensors. When one of a plurality of operation modes is selected, the kind of sensor, which is considered to be necessary in the selected operation mode, is selected, and then the analysis process is executed. Thus, the wearable terminal 10 with higher extendability can be realized, for example, such that a sensor of a necessary kind in each operation mode is added by the setup for update of software.

Additionally, in the above-described embodiment, from the simple analysis result by the wearable terminal 10, the alarm output, such as generation of buzzer sound, is executed when necessary. Thus, based on the firmware which is properly updated and set up, the terminal-side device, even as the single unit, can execute necessary alarming when necessary.

Additionally, in the above-described embodiment, the server apparatus SV side executes the detailed analysis by using not only the wearable terminal 10 but also the moving image file acquired by the digital camera DC which shoots the user US. Thus, the detailed analysis process can be executed based on a greater number of factors, and the result of the analysis can be utilized for the setup for update of firmware of the wearable terminal 10.

In the present embodiment, the description was given of the system in which the digital camera DC is used in addition to the wearable terminal 10 functioning as the terminal device, and the wearable terminal 10 and the digital camera DC are connected to the server apparatus SV by using the smartphone SP as an intermediate device. However, the wearable terminal 10 may be configured to include communication means for directly communicating with the server apparatus SV and the digital camera DC.

Besides, when the server apparatus SV executes the detailed analysis process, it is not always necessary to use the moving image file captured by the digital camera DC.

Additionally, in the above-described embodiment, the server apparatus SV transmits the update software itself of the wearable terminal 10 to the wearable terminal 10. However, difference information for updating the software of the wearable terminal 10 may be transmitted to the wearable terminal 10.

Additionally, in the above-described embodiment, when the difference between the result of the simple analysis on the wearable terminal 10 side and the result of the detailed analysis on the server apparatus SV side deviates from the preset tolerable range, the software that is available as update software in the wearable terminal 10, by which the analysis result considered to be closest to the result of the detailed analysis process was obtained, is transmitted to the wearable terminal 10. Alternatively, in accordance with the magnitude of the difference between the result of the simple analysis on the wearable terminal 10 side and the result of the detailed analysis on the server apparatus SV side, such software as to decrease the magnitude of the difference may be transmitted to the wearable terminal 10.

Additionally, in the above-described embodiment, the wearable terminal 10, which executes an analysis process of sports or the like, is assumed. The sensor data acquired by the wearable terminal 10 is subjected to the simple analysis by the software of the wearable terminal 10, this software being designed to analyze sports or the like. The acquired sensor data and the analysis result are mutually associated, and the associated sensor data and analysis result are transmitted to the server apparatus SV. The transmitted sensor data is subjected to the detailed analysis by the software of the server apparatus SV. In accordance with the comparison result between the analysis result of the wearable terminal 10 and the analysis result of the server apparatus SV, the update software of the wearable terminal 10 is transmitted to the wearable terminal 10. However, instead of the wearable terminal 10, for example, a robot, which has a conversation function with humans and is connectable to the network, may be assumed, and the update of software may be applied to the update of the speech recognition software or conversation software in the robot.

In this case, speech data, which the user utters to the robot, corresponds to the sensor data, and a recognition result of recognition of the user's speech data by the robot and speech data that the robot utters in response to the user's speech data correspond to the result of simple analysis of responses of the speech recognition software or conversation software of the robot.

Besides, the present invention is not limited to the above-described embodiment, and can be variously modified without departing from the scope of the present invention in practical stages. In addition, the embodiments may be appropriately combined as much as possible and practiced and, in this case, the combined advantageous effects can be obtained. Furthermore, the above-described embodiment incorporates inventions of various stages, and various inventions can be extracted by appropriate combinations of the disclosed constituent elements. For example, even if some constituent elements are omitted from all the constituent elements disclosed in the embodiment, a configuration from which some constituent elements are omitted can be extracted as an invention if the problem described in the specification can be solved and the advantageous effects described in the specification can be obtained.

What is claimed is:

1. A server apparatus connected to a terminal device via a network, comprising:
a receiver configured to receive, from the terminal device, data and an analysis result of the data;
a first analysis unit configured to analyze, using software of the server apparatus, the data received from the terminal device, using the software of the server apparatus being different from software of the terminal apparatus and having a higher precision than the software of the terminal apparatus; and
a first transmitter configured to transmit information for updating the software of the terminal device, based on the analysis result received from the terminal device and an analysis result obtained by the first analysis unit.

2. The server apparatus of claim 1, further comprising a determination unit configured to determine presence/absence of necessity for update of the software of the terminal device, based on the analysis result received from the terminal device and the analysis result obtained by the first analysis unit, and
wherein the first transmitter is configured to transmit the information for updating the software of the terminal device, in accordance with a determination result by the determination unit.

3. The server apparatus of claim 1, wherein the terminal device includes:
a plurality of kinds of sensors;
a selector configured to select one of a plurality of action genres;
an input unit configured to input sensor data items from the plurality of kinds of sensors;
a second analysis unit configured to analyze, using the software of the terminal device, the sensor data items to determine an action of a user holding the terminal device in the action genre selected by the selector; and
a second transmitter configured to transmit the sensor data items input by the input unit and an analysis result obtained by the second analysis unit, the sensor data items input by the input unit being associated with the analysis result obtained by the second analysis unit, and
the first analysis unit of the server apparatus is configured to analyze, using the software of the server apparatus, the action genre selected by the selector, which are received from the terminal device, and the sensor data items, to determine the action of the user holding the terminal device in the action genre selected by the selector and received from the terminal device.

4. The server apparatus of claim 1,
wherein the first analysis unit of the server apparatus is configured to analyze, using the software of the server apparatus, the data received from the terminal device and a state data obtained from an auxiliary device configured to detect the state data of the user holding the terminal device, the auxiliary device being separate from the terminal device.

5. A data processing method applied to a server apparatus connected to a terminal device via a network, comprising:
receiving, from the terminal device, data, and an analysis result obtained by analyzing the data, using software of the terminal device;
analyzing, using software of the server apparatus, the data received from the terminal device, the software of the server apparatus being different from the software of the terminal apparatus and having a higher precision than the software of the terminal apparatus; and
transmitting information for updating the software of the terminal device, based on the analysis result received from the terminal device and an analysis result obtained in the analysis.

6. A non-transitory computer-readable storage medium having a program stored thereon which controls a computer of a server apparatus connected to a terminal device via a network, to perform functions comprising:
receiving, from the terminal device, data, and an analysis result obtained by analyzing the data, using software of the terminal device;
analyzing, using software of the server apparatus, the data received from the terminal device, the software of the server apparatus being different from the software of the terminal apparatus and having a higher precision than the software of the terminal apparatus; and
transmitting information for updating the software of the terminal device, based on the analysis result received from the terminal device and an analysis result obtained in the analysis.

7. A terminal device connected to a server apparatus via a network, comprising:
an input unit configured to input data;
an analysis unit configured to analyze, using software of the terminal device, the data input by the input unit; and
a transmitter configured to transmit the data input by the input unit and an analysis result obtained by the analysis unit to the server apparatus, the data input by the input unit being associated with the analysis result obtained by the analysis unit to the server apparatus.

8. The terminal device of claim 7, further comprising:
a plurality of kinds of sensors; and
a selector configured to select one of a plurality of action genres,
wherein the input unit is configured to input sensor data items from the plurality of kinds of sensors, and
the analysis unit is configured to analyze, using the software of the terminal device, the sensor data items to determine an action of a user holding the terminal device in the action genre selected by the selector.

9. The terminal device of claim 7, further comprising an alarm device configured to compare the analysis result obtained by the analysis unit and preset reference data, and to perform alarming corresponding to a result of the comparing.

10. A data processing method applied to a terminal device connected to a server apparatus via a network, comprising:
inputting data;
analyzing the input data, using software of the terminal device; and
transmitting the input data and an analysis result obtained from the analysis to the server apparatus, the input data being associated with the analysis result obtained from the analysis.

11. A non-transitory computer-readable storage medium having a program stored thereon which controls a computer of a terminal device connected to a server apparatus via a network, to perform functions comprising:
inputting data;
analyzing the input data, using software of the terminal device; and
transmitting the input data and an analysis result obtained from the analysis to the server apparatus, the input data being associated with the analysis result obtained from the analysis.
